(19) United States
(12) Patent Application Publication
(10) Pub. No.: US 2008/0098885 A1
(43) Pub. Date: May 1, 2008

(54) Piston Assembly

(75) Inventor: Douglas Oliver Hall, Jeffersonville, VT (US)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, US

(73) Assignee: Husky Injection Molding Systems Ltd., Bolton (CA)

(21) Appl. No.: 11/555,008

(22) Filed: Oct. 31, 2006

(51) Int. Cl. F16J 1/00

(52) U.S. Cl. 92/172

(57) ABSTRACT

A device, method, and system for a piston assembly are disclosed herein. A piston may have an outer circumferential groove. A semi-rigid ring seal may be sized and shaped to fit within the circumferential groove. The semi-rigid ring seal may provide a seal between the piston and a bore of the piston. The semi-rigid ring may be positioned during assembly within the outer circumferential groove without stretching the semi-rigid ring.

### TECHNICAL FIELD OF THE INVENTION

The present invention relates to pistons and more particularly, relates a piston assembly with a semi-rigid ring providing a seal between the piston and a bore.

### BACKGROUND INFORMATION

In injection molding systems, pistons may be used to move hot runner valve gate stems and various other components during operation of the injection molding system. Pistons may also be used to move the material throughout the system, for example, a shooting pot piston. During the operation of the hot runner system heating devices are used to regulate the temperature and/or pressure of the material within the injection manifold to ensure that the material does not become too cool and solidify.

Due to extreme temperature and pressure observed during the injection molding process, piston seals may deteriorate or leak during operation and require replacement, thereby requiring machine downtime and reducing the production level of the injection molding system. The piston seals may also be deformed during installation of the piston seal resulting in leaks or increasing the rate of deterioration.

Accordingly, what is needed is an improved device, system, and method for a piston assembly that can withstand high temperatures and operate for extended periods of time, thereby reducing downtime of machinery. Embodiments of the piston assembly may provide an airtight seal. Embodiments of the piston assembly may reduce the possibility of resin leakage, thereby reducing the downtime of the entire hot runner system, reducing the potential damage to the hot runner system, and reducing the possibility of serious injury to operators.

### SUMMARY OF THE INVENTION

According to one exemplary embodiment, the present invention features a piston assembly. The piston assembly may have a piston, which may have a top portion and a bottom portion. The top portion couples to the bottom portion providing an outer circumferential groove. A semi-rigid ring seal may be sized and shaped to fit within the circumferential groove and provide a seal between the piston and a bore of piston.

In an alternative embodiment, the semi-rigid ring seal may be sized and shaped to provide an airtight seal between the piston and the bore. In another embodiment, the semi-rigid ring seal may be a compressed fiberglass material, a braided PolyTetraFluoroEthylene yarn, expanded graphite molded packing, or expanded graphite braided packing. In another embodiment, the top portion, the bottom portion, and the semi-rigid seal may be configured to provide assembly of the semi-rigid seal without stretching the semi-rigid seal. In another embodiment, the semi-rigid ring seal may have reinforced corners at an inner circumferential top and bottom rigid and an outer circumferential top and bottom rigid. In yet another embodiment, the piston may have a second outer circumferential groove located between the semi-rigid ring seal and an application side of the piston. A piston guide ring may be sized and shaped to fit within the second circumferential groove and provide a seal between the piston and a bore.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the following claims.

### BRIEF DESCRIPTION OF THE DRAWINGS

These and other features and advantages of the present invention will be better understood by reading the following detailed description, taken together with the drawings wherein:

FIG. 1 is cross-sectional view of a piston assembly within a bore according to a first exemplary embodiment;

FIG. 2A is a cross-sectional view of the piston assembly according to the first exemplary embodiment;

FIG. 2B is an exploded cross-sectional view of the piston assembly according to the first exemplary embodiment;

FIG. 3 is a top plan view of the piston assembly according to the first exemplary embodiment;

FIG. 4 is a cross-sectional view of the piston assembly within a bore according to a second exemplary embodiment; and

FIG. 5 is a cross-sectional view of the piston assembly within a bore according to a third exemplary embodiment.

### DETAILED DESCRIPTION INCLUDING PREFERRED EMBODIMENTS

According to one embodiment, the present invention features an improved piston assembly. The piston assembly may provide a durable, airtight piston that may operate in high temperature applications. In one exemplary embodiment, the piston assembly may be used within hot runner mold injection systems. The pistons may be used to move molten material throughout the system or to move components of the system during operation of the system. The exemplary embodiments described herein may be demonstrated for use in plastic mold injection systems, however, it should be understood that the exemplary aspects are not limited to use of pistons in mold injection systems. Details of a piston for a mold injection system are disclosed in U.S. Pat. No. 6,343,925 titled: “Hot runner valve gate piston assembly” to Jenko, which in incorporate herein.

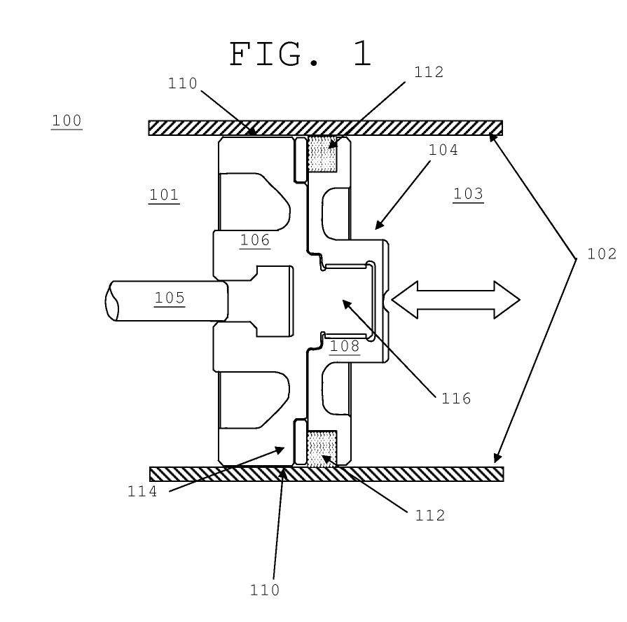

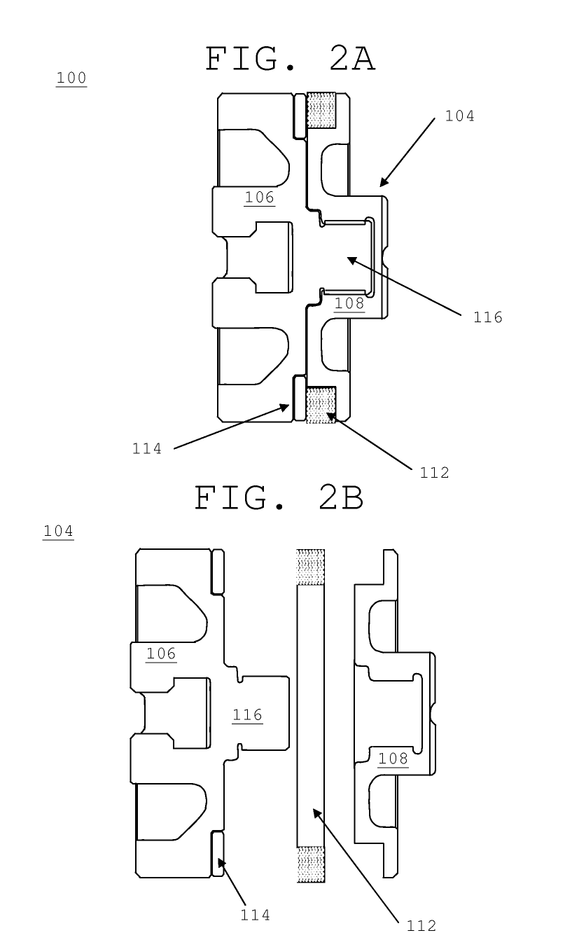

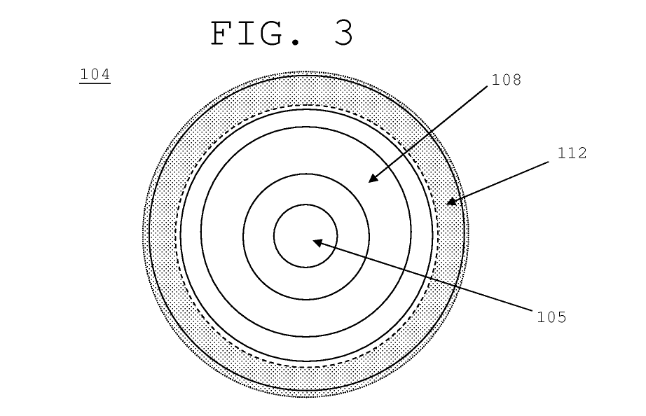

Referring to FIGS. 1-3, a piston assembly 100 according to a first exemplary embodiment is within the wall of a piston bore 102 or cylinder. The piston allows for the transfer of pressure in the piston bore 102 to a mechanical force “applied to” or “received by” the piston 104 (in the direction of the arrow shown). A shaft 105 may be coupled to the piston 104 to apply or receive the force applied to the piston 104. In pneumatic applications air may be supplied to the chamber within the piston bore 102. The piston bore 102 may have two chambers a bottom chamber 101 and a top chamber 103. The pressure produced within one of the chambers 101, 103 drives the piston 104 in a direction opposite the chamber producing the pressure. A vacuum may also be used in one of the chambers 101, 103 to pull the piston 104 in the direction of the chamber providing the vacuum.

The piston 104 may have a piston bottom 106 and a piston top 108. The piston 104 may be designed to provide a clearance gap 110 between the piston bore 102 walls and the sides of the piston 104. The clearance gap 110 is designed to allow movement of the piston 104 within the piston bore 102 but prevent or minimize leakage from one chamber to the other. The design of the clearance gap 110 is further complicated by the thermal expansion and contraction of the piston 104 and piston bore 102.

A piston ring seal 112 may be located between the piston bottom 106 and piston top 108. The piston ring seal 112 may be a semi-rigid fiber material. The material may help prevent or minimize leaking between the piston 104 and piston bore 102. The piston ring seal 112 may be made of a compressed fiberglass material. The rigidness of the piston ring seal 112 may be designed to prevent or minimize the breakdown of the seal during operation of the piston assembly 100. The rigidness and fiber structure may also be design to prevent a portion of the piston ring seal 112 from being blown or sucked into a chamber of the piston bore 102 and possible contaminating fluids in the chambers. The piston ring seal 112 may also be designed with reinforced edges adding additional structure to the piston ring seal 112.

The piston ring seal 112 may be made of a braided PolyTetraFluoroEthylene (PTFE) yarn. The PTFE yarn may be, for example, Aidmer76-020 Kevlar fiber with PTFE braided packing, manufactured by Aidmer Inc. of Jiujiang City, Jiangxi Province, China. The PTFE yarn may have reinforced edges on one or more inner and outer edges/sides of the piston ring seal 112. The piston seal 112 may also be made of an expanded graphite molded packing or an expanded graphite braided packing. The piston ring seal 112 may also be a combination of one or more characteristics or material of the previous exemplary materials.

The piston assembly 100 according to a first exemplary embodiment may be constructed without significantly stretching or deforming the piston ring seal 112. A seal support 114 may position onto the piston bottom 106 within a groove around the circumference of the piston bottom 106. The seal support 114 may be made of the same or different material as the piston. The seal support 114 may be a ring that provides a supporting surface for the piston ring seal 112. The piston ring seal 112 may be positioned within a groove around the circumference of the piston top 108. The piston top 108 may be coupled to the piston bottom 106. The coupling may be a frictional fit to a hub 116 of the piston bottom 106 pressed into a receiving portion of the piston top 108. The piston assembly 100 is not limited to a friction fit coupling. Other fasteners or fastening method may be used, for example but not limited to, threads, welds, rivets, lugs, or epoxies. The piston assembly 100 may be positioned with in the piston bore 102.

With reference to the hot runner mold injection system, the piston bore 102 may be located within a hot runner manifold containing plastic melt channels and heaters. The heating device, for example an electrical resistance wire or the like, of the manifold may be in close proximity to the passageway supplying molten resin. The piston 104 may drive the shaft 105 through a bushing to align the melt channel in the bushing with melt channel in the manifold. A nozzle housing may be urged against the head of the bushing by a spring washer that rests on a titanium insulator located in a channel in a manifold plate. The nozzle housing may also be heated by a heater and carries a tip that locates the housing in a mold cavity insert. As the manifold is heated by the heaters, and indirectly by the nozzle heater, the piston assembly 100 may operate in an environment of high temperatures ranging from about 200 to 475 Celsius.

The piston assembly 104 may couple to a valve stem via the shaft 105. Air may be used to control the position of the piston 104 and the valve stem via set screw such that when the piston 104 is moved the stem moves. The piston ring seal 112 which slides on the inner surface of piston bore 102 maintaining an air seal between the opposed faces of the piston 104 such that when compressed air is admitted via a channel in the top chamber of the piston bore 102 it causes the piston 104 to move downward, thereby closing the gate with the stem. When compressed air is admitted via a hole in the bottom portion of the piston bore 102, it causes the piston 104 to move upward thereby opening the gate by retracting stem.

The piston bore 102 may be a thin walled metal part and has its upper end formed in a slightly raised, annular bevel such that this end wall acts like a spring, constantly urging the cylinder toward the manifold. The piston bore's 102 lower edge fits snugly in a recessed annular step in a backup pad. Sufficient of the compressive sealing force from a spring washer is directed through the walls of piston bore 102 such that an air seal is maintained at the lower edge and at the bevel at all operating temperatures of the hot runner mold injection system. This ensures there is no or minimal leakage of air from the chamber of the piston bore 102 during operation. Forces required to seal piston bore 102 may be in the order of 1,000-2,000 lbs.

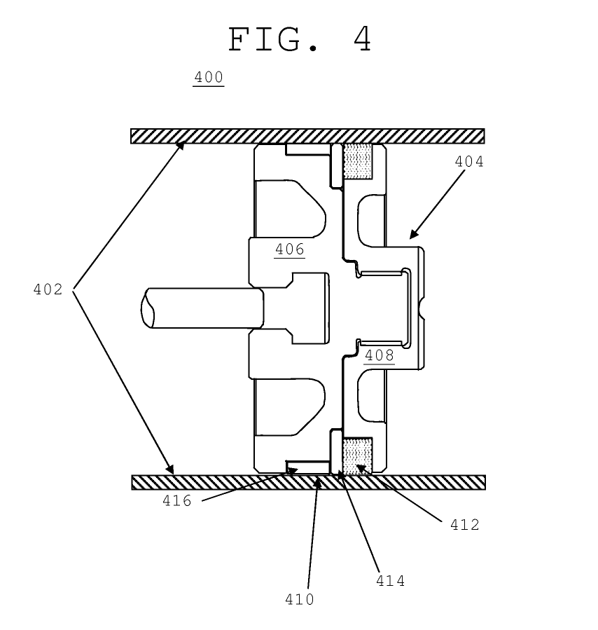

Referring to FIG. 4, a piston assembly 400 according to a second exemplary embodiment of the invention. The piston 404 allows for the transfer of pressure in the piston bore 402 to a mechanical force “applied to” or “received by” the piston 404 as previously described in the first exemplary embodiment. The piston 404 may have piston bottom 406 and a piston top 408. The piston 404 may be designed to provide a clearance gap 410 between the piston bore 402 walls and the sides of the piston 404. The clearance gap 410 is designed to allow movement of the piston 404 within the piston bore 402 but prevent or minimize leakage from one chamber to the other. The design of the clearance gap 410 is further complicated by the thermal expansion and contraction of the piston 404 and piston bore 402.

A piston guide ring 416 may be provided between the piston 404 and the piston bore 402 walls. The piston guide ring 416 may provide a more consistent clearance gap 410. The piston guide ring 416 also provides additional expansion and contraction room for the piston 404. The piston guide ring 416 may be sized slightly larger than the diameter of the piston 404. The piston guide ring 416 may be made of different material from the piston 404 to control wear on the piston bore 402 and changes due to thermal expansion and contraction. This allows the piston guide ring 416 to guide the piston 404 as the piston 404 moves in the piston bore 402.

A piston seal 412 may be located between the piston bottom 406 and piston top 408. The piston seal 412 may be similar in design and construction as previously described with regard to the first exemplary embodiment. The piston seal's semi-rigid fiber material provides an additional barrier preventing leakage and allowing the piston 404 to move within the piston bore.

The piston assembly 400 according to a second exemplary embodiment may be constructed without significantly stretching or deforming the piston seal 412. A piston guide ring 416 may be positioned onto the piston bottom 406. A seal support 414 may be positioned on top of the piston guide ring 416. The seal support 414 may provide a supporting surface for the piston seal 412. The piston seal 412 may be position within the piston top 408. The piston top 408 may be coupled to the piston bottom 406 as previously described with regard to the first exemplary embodiment. The piston assembly 400 may be positioned with in the piston bore 402 by slightly compressing the piston guide ring 416 and piston seal 412.

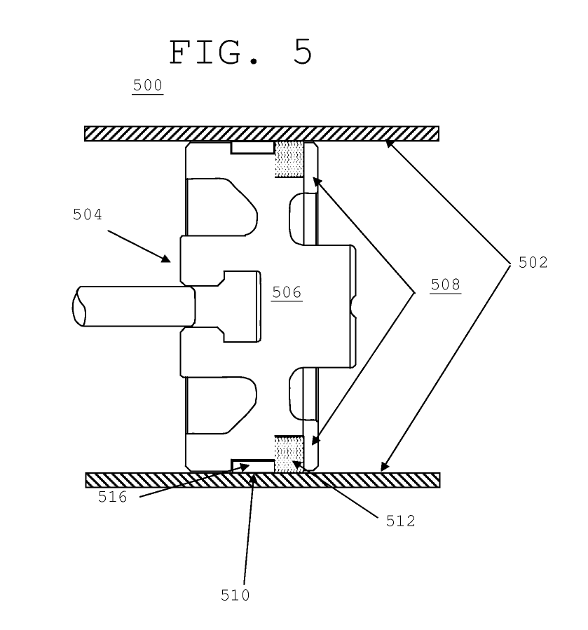

Referring to FIG. 5, a piston assembly 500 according to a third exemplary embodiment of the invention. The piston 504 allows for the transfer of pressure in the piston bore 502 to a mechanical force applied to or received by the piston 504 as previously described in the first exemplary embodiment. The piston 504 may have a piston bottom 506 and a piston top 508. The piston 504 may be designed to provide a clearance gap 510 between the piston bore 502 walls, a piston guide ring 516, and the sides of the piston 504 as previously described with regard to the second exemplary embodiment.

A piston seal 512 may be located between the piston bottom 506 and piston top 508. The piston seal 512 may be similar in design and construction as previously described with regard to the first exemplary embodiment. The piston seal's 512 semi-rigid fiber material provides an additional barrier preventing leakage and allowing the piston 504 to move within the piston bore 502.

The piston assembly 500 according to a third exemplary embodiment may be constructed without significantly stretching or deforming the piston seal 512. A piston guide ring 516 may position onto the piston bottom 506. The piston guide ring 516 may provide a supporting surface for the piston seal 512. The piston seal 512 may also be position within the piston bottom 506. The piston top 508 may be coupled to the piston bottom 506 as previously described with regard to the first exemplary embodiment. The piston top 508 may be coupled to the piston bottom 506 using, for example but not limited to, threads, welds, rivets, lugs, or epoxies. The piston assembly 500 may be positioned within the piston bore 502 by slightly compressing the piston guide ring 516 and piston seal 512.

The piston assembly 500 is not limited to the sizes or shapes of the piston tops and piston bottoms described in the exemplary embodiments. A variety of piston top and piston bottom shapes and methods for coupling may be used to provide a piston assemble without stretching or deforming the piston seal. The size and shape of the piston component may be design based on the intended application of the piston assembly. The design of the coupling used to couple the piston top and piston bottom may be based on the size and shape of the components as well as the intended application of the piston assembly. In one exemplary embodiment, the piston may be constructed of a single piece. The piston seal may be formed and mold within a groove of the piston. According to this exemplary embodiment, the piston seal may be provided on a single piston structure.

As mentioned above, the present invention is not intended to be limited to a system or method which must satisfy one or more of any stated or implied object or feature of the invention and should not be limited to the preferred, exemplary, or primary embodiment(s) described herein. The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as is suited to the particular use contemplated. All such modifications and variations are within the scope of the invention as determined by the claims when interpreted in accordance with breadth to which they are fairly, legally and equitably entitled.

The invention claimed is:

1. A piston assembly comprising:
a piston having a top portion and a bottom portion wherein the top portion couples to the bottom portion providing an outer circumferential groove; and
a semi-rigid ring seal sized and shaped to fit within the circumferential groove and provide a seal between the piston and a bore.

2. A piston assembly of claim 1, wherein the semi-rigid ring seal is sized and shaped to provide an airtight seal between the piston and the bore

3. A piston assembly of claim 1, wherein the semi-rigid ring seal is a compressed fiberglass material.

4. A piston assembly of claim 1, wherein the piston assembly is configured for use in applications above about 200 degrees Celsius.

5. A piston assembly of claim 1, wherein the top portion, the bottom portion, and the semi-rigid seal are configured to provide assembly of the semi-rigid seal without stretching the semi-rigid seal.

6. A piston assembly of claim 1, wherein the semi-rigid ring seal is made of a braided PolyTetraFluoroEthylene yarn.

7. A piston assembly of claim 1, wherein the semi-rigid ring seal has reinforced corners at an inner circumferential top and bottom rigid and an outer circumferential top and bottom rigid.

8. A piston assembly of claim 1, wherein the semi-rigid ring seal is made from one of a group consisting of: expanded graphite molded packing and expanded graphite braided packing.

9. A piston assembly of claim 1, further comprising:
the piston having a second outer circumferential groove located between the semi-rigid ring seal and an application side of the piston; and
a piston guide ring sized and shaped to fit within the second circumferential groove and provide a seal between the piston and a bore.

10. A piston assembly comprising:
a piston having an outer circumferential groove; and
a semi-rigid, fiber ring seal sized and shaped to fit within the circumferential groove and provide a seal between the piston and a bore wherein the semi-rigid ring is positioned during assembly within the outer circumferential groove without stretching.

11. A piston assembly of claim 10, wherein the semi-rigid ring seal is sized and shaped to provide an airtight seal between the piston and bore.

12. A piston assembly of claim 10, wherein the piston assembly is configured for use in injection molding application.

13. A piston assembly of claim 10, wherein the semi-rigid ring seal is made from one of a group consisting of: a compressed fiberglass material, a braided PolyTetraFluoroEthylene yarn, an expanded graphite molded packing, and an expanded graphite braided packing.

14. A piston assembly of claim 10, wherein the semi-rigid ring seal has reinforced corners at an inner circumferential top and bottom rigid and an outer circumferential top and bottom rigid.

15. A hot runner manifold system comprising:
a heated manifold comprising resin channels and a piston bore feed by pneumatic channels;
a piston having a top portion and a bottom portion wherein the top portion couples to the bottom portion providing an outer circumferential groove; and
a semi-rigid ring seal sized and shaped to fit within the circumferential groove and provide an airtight seal between the piston and the piston bore.

16. A hot runner manifold system of claim 15, wherein the top portion, the bottom portion, and the semi-rigid seal are configured to provide assembly of the semi-rigid seal without stretching the semi-rigid seal.

17. A hot runner manifold system of claim 15, wherein the piston and semi-rigid ring seal are configured for use in applications above about 200 degrees Celsius.

18. A hot runner manifold system of claim 15, wherein the semi-rigid ring seal is made from one of a group consisting of: a compressed fiberglass material, a braided PolyTetraFluoroEthylene yarn, an expanded graphite molded packing, and an expanded graphite braided packing.

19. A hot runner manifold system of claim 15, wherein the semi-rigid ring seal has reinforced corners at an inner circumferential top and bottom rigid and an outer circumferential top and bottom rigid.

20. A hot runner manifold system of claim 15, wherein the piston bore and the piston are configured to maintain a clearance gap to prevent extraction of the semi-rigid ring seal during operation.
